(19) United States
(12) Patent Application Publication
(10) Pub. No.: US 2017/0193705 A1
(43) Pub. Date: Jul. 6, 2017

(54) PATH VISUALIZATION FOR MOTION PLANNING

(71) Applicant: DAQRI, LLC, Los Angeles, CA (US)

(72) Inventors: Brian Mullins, Altadena, CA (US); Matthew Kammerait, Studio City, CA (US); Frank Chester Irving, JR., Woodland Hills, CA (US)

(21) Appl. No.: 15/396,109

(22) Filed: Dec. 30, 2016

Related U.S. Application Data
(60) Provisional application No. 62/273,612, filed on Dec. 31, 2015.

(51) Int. Cl. G06T 19/00; G06K 9/00; G06T 19/20; G06F 3/01

(52) U.S. Cl. CPC G06T 19/006; G06F 3/011; G06K 9/00671; G06T 19/20; G06T 19/003; G06T 2200/04

(57) ABSTRACT

An augmented reality device includes one or more sensors for imaging and/or detecting an environment and a transparent display for displaying virtual objects. The augmented reality device monitors various biometric attributes of a user and determines the user's location within the environment. The augmented reality device determines a virtual path from the user's location to a selected destination within the environment using the monitored biometric attributes as one or more constraints in the pathfinding determination. The determined virtual path is displayed on the transparent display as a virtual object such that it appears overlaid on the user's environment. The augmented reality device monitors the user as he or she traverses the virtual path through the environment, and updates the virtual path in response to changes in one or more of the user's monitored biometric attributes.

### CROSS-REFERENCE TO RELATED APPLICATIONS

This application claims the benefit of priority to U.S. Pat. App. No. 62/273,612, titled “PATH VISUALIZATION FOR MOTION PLANNING” and filed Dec. 31, 2015, the disclosure of which is hereby incorporated by reference in its entirety.

### TECHNICAL FIELD

The subject matter disclosed herein generally relates to path visualization for motion planning, and in particular, using augmented reality to visualize a path where the path is determined from biometric measurements and terrain data.

### BACKGROUND

Augmented reality (AR) is a live direct or indirect view of a physical, real-world environment whose elements are augmented (or supplemented) by computer-generated sensory input such as sound, video, graphics or GPS data. An AR view of an environment is conventionally in real-time and in semantic context with environmental elements. Using computer vision and objection recognition, the information about an environment can become interactive and digitally manipulatable. Further still, with the aid of computer vision techniques, computer-generated information about the environment and its objects can appear overlaid on real-world objects.

### BRIEF DESCRIPTION OF THE DRAWINGS

Some embodiments are illustrated by way of example and not limitation in the figures of the accompanying drawings.

FIG. 1 is a block diagram illustrating an augmented reality device, according to an example embodiment, coupled to a transparent acousto-optical display.

FIGS. 2A-2B illustrate modules and data leveraged by the augmented reality device of FIG. 1, according to an example embodiment.

FIG. 3 illustrates an environment where an augmented reality device displays a virtual path for a user to follow, according to an example embodiment

FIG. 4 illustrates another view of the virtual path displayed by the augmented reality device, according to an example embodiment.

FIG. 5 illustrates another environment where the augmented reality device displays a virtual path for the user to follow, according to an example embodiment.

FIG. 6 illustrates a method for initializing the augmented reality device of FIG. 1, in accordance with an example embodiment.

FIGS. 7A-7B illustrate a method for selecting a pathfinding algorithm and determining a virtual path for a user to follow using the augmented reality device of FIG. 1, according to an example embodiment.

FIG. 8 is a block diagram illustrating an example of a software architecture that may be installed on a machine, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

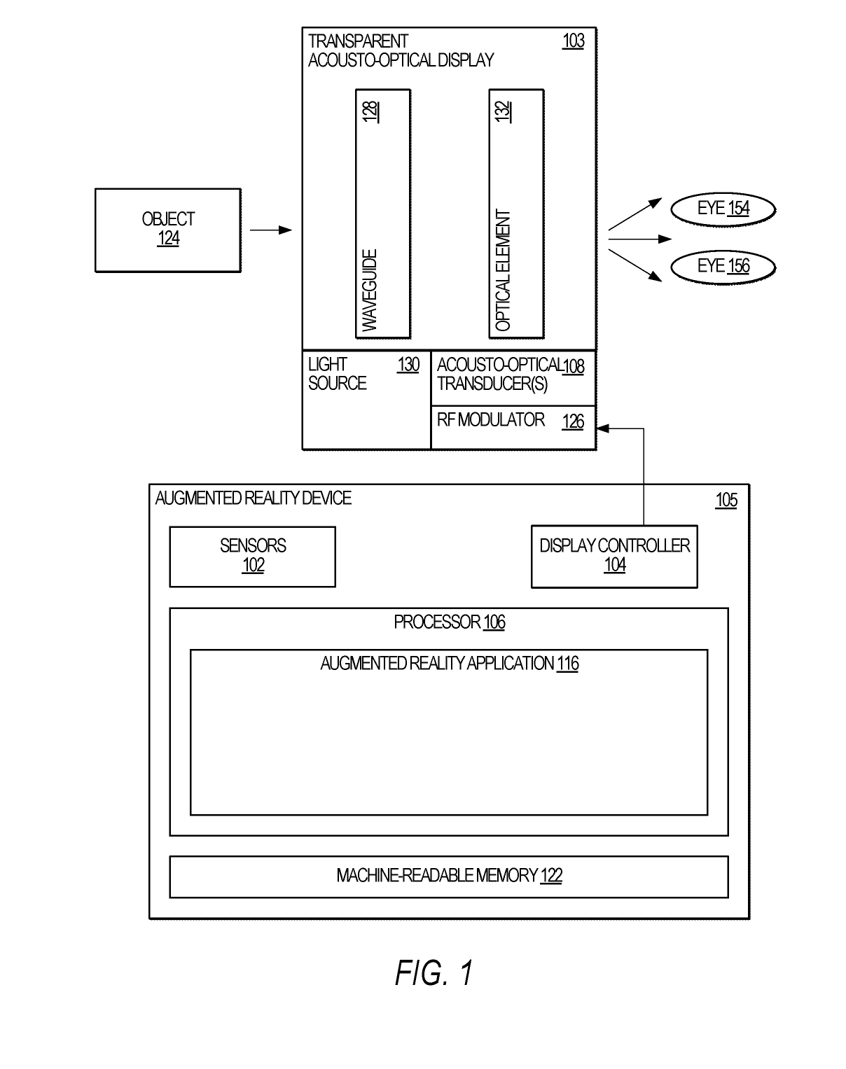

FIG. 1 is a block diagram illustrating an augmented reality device 105, according to an example embodiment, coupled to a transparent acousto-optical display 103. In general, an acousto-optical display is a transparent display that is controlled by acoustic waves delivered via an acoustic element, such as a surface acoustic wave transducer. The transparent acousto-optical display 103 includes a one or more waveguides secured to an optical element 132 (or medium). Light reflected off an object 124 travels through one or more layers of the waveguide 128 and/or the optical element 132 to eyes 154, 156 of a user. In one embodiment, one or more waveguides 128 transport light from a dedicated light source 130 that is then diffracted through one or more layers of the optical elements 132. Examples of the light source 130 include laser light, light emitting diodes (“LEDS”), organic light emitting diodes (“OLEDS”), cold cathode fluorescent lamps (“CCFLS”), or combinations thereof. Where the light source 130 is laser light, the light source 130 may emit the laser light in the wavelengths of 620-750 nm (e.g., red light), 450-495 nm (e.g., blue light), and/or 495-570 nm (e.g., green light). In some embodiments, a combination of laser lights is used as the light source 130. The transparent display 103 may also include, for example, a transparent OLED. In other embodiments, the transparent display 103 includes a reflective surface to reflect an image projected onto the surface of the transparent display 103 from an external source such as an external projector. Additionally, or alternatively, the transparent display 103 includes a touchscreen display configured to receive a user input via a contact on the touchscreen display. The transparent display 103 may include a screen or monitor configured to display images generated by the processor 106. In another example, the optical element 132 may be transparent or semi-opaque so that the user can see through it (e.g., a Heads-Up Display).

The acousto-optical display 103 may be communicatively coupled to one or more acousto-optical transducers 108, which modify the optical properties of the optical element 132 at a high frequency. For example, the optical properties of the optical element 132 may be modified at a rate high enough so that individual changes are not discernable to the naked eyes 154, 156 of the user. For example, the transmitted light may be modulated at a rate of 60 Hz or more.

The acousto-optical transducers 108 are communicatively coupled to one or more radiofrequency (“RF”) modulators 126. The RF modulator 126 generates and modulates an electrical signal provided to the acousto-optical transducers 108 to generate an acoustic wave on the surface of the optical element, which can dynamically change optical properties, such as the diffraction of light out of the optical element 132, at a rate faster than perceived with human eyes 154, 156.

The RF modulator 126 is one example of means to modulate the optical element 132 in the transparent acousto-optical display 103. The RF modulator 126 operates in conjunction with the display controller 104 and the acousto-optical transducers 108 to allow for holographic content to be displayed via the optical element 132. As discussed below, the display controller 104 modifies a projection of the virtual content in the optical element 132 as the user moves around the object 116. In response, the acousto-optical transducers 108 modify the holographic view of the virtual content perceived by the eyes 154, 156 based on the user's movement or other relevant positional information. For example, additionally or alternatively to the user's movement, the holographic view of the virtual content may be changed in response to changes in environmental conditions, user-provided input, changes in objects within the environment, and other such information or combination of information.

The AR device 105 produces one or more images and signals, such as holographic signals and/or images, via the transparent acousto-optical display 103 using the RF modulator(s) 126 and the acousto-optical transducers 108. In one embodiment, the AR device 105 includes sensors 102, a display controller 104, a processor 106, and a machine-readable memory 122. For example, the AR device 105 may be part of a wearable computing device (e.g., glasses or a helmet), a desktop computer, a vehicle computer, a tablet computer, a navigational device, a portable media device, or a smart phone of a user. The user may be a human user (e.g., a human being), a machine user (e.g., a computer configured by a software program to interact with the AR device 105), or any suitable combination thereof (e.g., a human assisted by a machine or a machine supervised by a human).

The sensors 102 include, for example, a proximity or location sensor (e.g., Near Field Communication, GPS, Bluetooth, Wi-Fi), one or more optical sensors (e.g., one or more visible sensors such as CMOS cameras and CCD cameras, one or more infrared cameras, one or more ultraviolet sensor, etc.), an orientation sensor (e.g., a gyroscope), one or more audio sensors (e.g., a unidirectional and/or omnidirectional microphone), one or more thermometers, one or more barometers, one or more humidity sensors, one or more EEG sensors, or any suitable combination thereof. For example, the sensors 102 may include a rear-facing camera and a front-facing camera in the viewing AR device 105. It is noted that the sensors 102 described herein are for illustration purposes; the sensors 102 are thus not limited to the ones described. In one embodiment, the sensors 102 generate internal tracking data of the AR device 105 to determine what the AR device 105 is capturing or looking at in the real physical world. Further still, a GPS of the sensors 102 provides the origin location of the user of the AR device 105 such that a path can be determined from the provided origin location to a selected destination (discussed further below).

The sensors 102 may also include a first depth sensor (e.g., a time-of-flight sensor) to measure the distance of the object 124 from the transparent display 103. The sensors 102 may also include a second depth sensor to measure the distance between the optical element 132 and the eyes 154, 156. The depth sensors facilitate the encoding of an image to be virtually overlaid on the object 124, such as a virtual path (e.g., the virtual image) overlaid on the terrain of the user's environment (e.g., the object 124).

In another example, the sensors 102 include an eye tracking device to track a relative position of the eye. The eye position data may be fed into the display controller 104 and the RF modulator 108 to generate a higher resolution version of the virtual object and further adjust the depth of field of the virtual object at a location in the transparent display corresponding to a current position of the eye. Further still, the eye tracking device facilitates selection of objects within the environment seen through the transparent acousto-optical display 103 and can be used to designate or select a destination point for a virtual path.

In addition, the sensors 102 include one or more biometric sensors for measuring various biometric features of the user of the AR device 105. In one embodiment, the biometric sensors may be physically separate from the AR device 105, such as where the biometric sensors are wearable sensors, but are communicatively coupled to the AR device 105 via one or more communication interfaces (e.g., USB, Bluetooth®, etc.). In this embodiment, the biometric sensors include, but are not limited to, an electrocardiogram, one or more electromyography sensors, such as those available from Myontec Ltd., located in Finland, or a sensor package, such as the BioModule™ BH3, available from the Zephyr Technology Corporation, located in Annapolis, Md. The biometric sensors provide such information about the user as heartrate, blood pressure, breathing rate, activity level, and other such biometric information. As discussed below, the biometric information is used as one or more constraints in formulating a path for a user to follow in navigating a given environment.

The display controller 104 communicates data signals to the transparent display 103 to display the virtual content. In another example, the display controller 104 communicates data signals to an external projector to project images of the virtual content onto the optical element 132 of the transparent display 103. The display controller 104 includes hardware that converts signals from the processor 106 to display such signals. In one embodiment, the display controller 104 is implemented as one or more graphical processing units (GPUs), such as those that are available from Advanced Micro Devices Inc. or NVidia Corporation.

The processor 106 may include an AR application 116 for processing an image of a real world physical object (e.g., object 116) and for generating a virtual object displayed by the transparent acousto-optical display 103 corresponding to the image of the object 116. In one embodiment, the real world physical object is a selected portion of a terrain or an environment, and the virtual object is a path for moving through the selected portion of the terrain or environment. As discussed below, the virtual object is depth encoded and appears overlaid on the selected portion of the environment via the acousto-optical display 103.

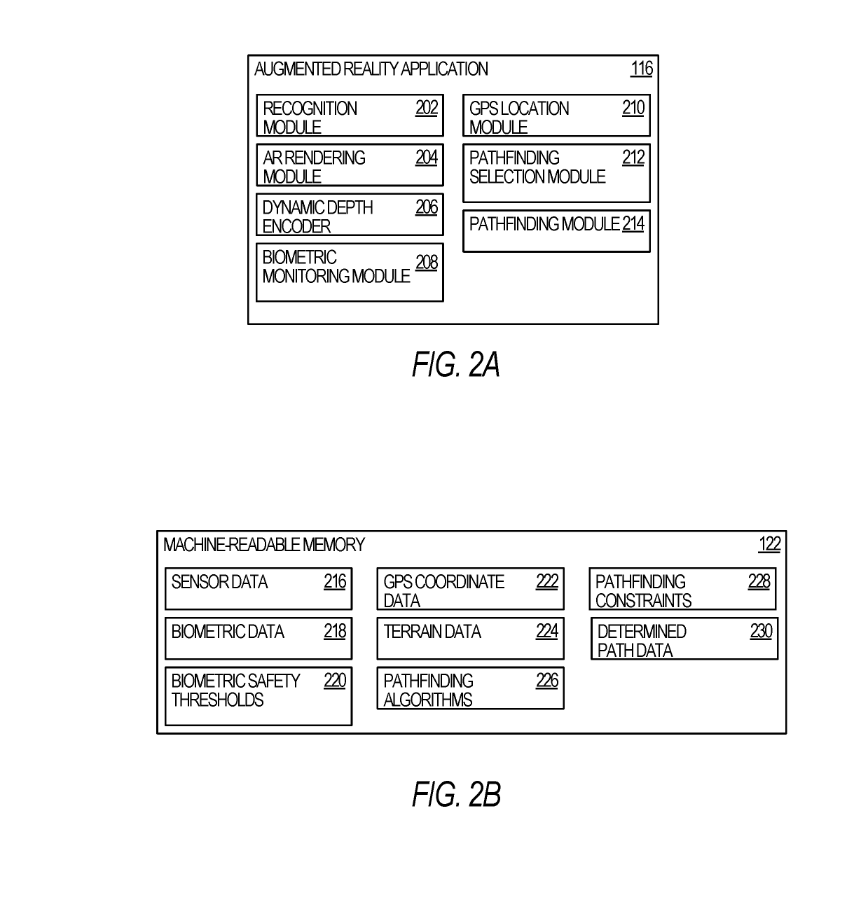

Referring to FIG. 2A is an illustration of the modules that comprise the AR application 116. In one embodiment, the modules include a recognition module 202, an AR rendering module 204, a dynamic depth encoder module 206, a biometric monitoring module 208, a GPS location module 210, a pathfinding selection module 212, and a pathfinding module 214. The modules 202-214 and/or the AR application 116 may be implemented using one or more computer-programming and/or scripting languages including, but not limited to, C, C++, C#, Java, Perl, Python, or any other such computer-programming and/or scripting language.

The machine-readable memory 122 includes data that supports the execution of the AR application 116. FIG. 2B illustrates the various types of data stored by the machine-readable memory 122, in accordance with an example embodiment. As shown in FIG. 2B, the data includes, but is not limited to, sensor data 216, biometric data 218, biometric safety thresholds 220, GPS coordinate data 222, terrain data 224, one or more pathfinding algorithms 226, one or more pathfinding constraints 228, and determined path data 230.

In one embodiment, the recognition module 202 identifies one or more objects near or surrounding the AR device 105. The recognition module 202 may detect, generate, and identify identifiers such as feature points of the physical object being viewed or pointed at by the AR device 105 using an optical device (e.g., sensors 102) of the AR device 105 to capture the image of the physical object. The image of the physical object may be stored as sensor data 216. As such, the recognition module 202 may be configured to identify one or more physical objects. The identification of the object may be performed in many different ways. For example, the recognition module 202 may determine feature points of the object based on several image frames of the object. The recognition module 202 also determines the identity of the object using one or more visual recognition algorithms. In another example, a unique identifier may be associated with the object. The unique identifier may be a unique wireless signal or a unique visual pattern such that the recognition module 202 can look up the identity of the object based on the unique identifier from a local or remote content database. In another example embodiment, the recognition module 202 includes a facial recognition algorithm to determine an identity of a subject or an object.

Furthermore, the recognition module 202 may be configured to determine whether the captured image matches an image locally stored in a local database of images and corresponding additional information (e.g., three-dimensional model and interactive features) in the machine-readable memory 122 of the AR device 105. In one embodiment, the recognition module 202 retrieves a primary content dataset from an external device, such as a server, and generates and updates a contextual content dataset based on an image captured with the AR device 105.

The AR rendering module 204 generates the virtual content based on the recognized or identified object 116. For example, the AR rendering module 204 generates a colorized path overlaid on the terrain (e.g., the identified object 116), where the path is determined by the pathfinding module 214. In this regard, the AR rendering module 204 may change or alter the appearance of the virtual content as the user moves about his or her environment (e.g., change the features of the colorized path relative to the movements of the user).

The dynamic depth encoder 206 determines depth information of the virtual content based on the depth of the content or portion of the content relative to the transparent acousto-optical display 103. In one embodiment, the depth information is stored as sensor data 216. The display controller 104 utilizes this depth information to generate the RF signal which drives the acousto-optical transducers 108. The generated surface acoustic wave in the optical element 132 alters the diffraction of light through the optical element 132 to produce a holographic image with the associated depth of field information of the content. Through acousto-optic modulation, light can be modulated through the optical element 132 at a high rate (e.g., frequency) so that the user does not perceive individual changes in the depth of field. In another example, the dynamic depth encoder 120 adjusts the depth of field based on sensor data from the sensors 102. For example, the depth of field may be increased based on the distance between the transparent display 103 and the object 116. In another example, the depth of field may be adjusted based on a direction in which the eyes are looking.

The biometric monitoring module 208 is configured to monitor one or more of the biometric sensors selected from the sensors 102. In one embodiment, the biometric monitoring module 208 is configured to monitor such biometric information as heart rate, activity level, heart rate variability, breathing rate, and other such biometric information or combination of biometric information. The biometric information monitored by the biometric monitoring module 208 is stored as the biometric data 218.

As discussed below, the biometric data 218 is monitored by the biometric module 208 to determine whether the user is exerting himself or herself as he or she traverses a given environment. In this regard, the biometric monitoring module 208 may first establish a baseline of biometric information representing the user at rest. Thereafter, the biometric monitoring module 208 may request that the user exert himself or herself to establish one or more biometric safety thresholds 220. The biometric safety thresholds 220 represents upper boundaries that indicate whether the user is over exerting himself or herself. Alternatively, the biometric monitoring module 208 may request that the user provide health-related information to establish the biometric safety thresholds 220, such as the user's height and/or weight, the user's age, the amount of weekly activity in which the user engages, any particular disabilities the user may have, such as confined by a wheelchair, or other such questions. In one embodiment, the answers to these questions each correspond to an entry in a lookup table, which then establishes one or more of the biometric safety thresholds 220 as a weighted value of the user's biometric data 218 while at rest.

Further still, the biometric safety thresholds 220 may be leveraged by the pathfinding module 214 in establishing one or more pathfinding constraints 228 for computing a path between an origin location of the user and a destination selected by user (e.g., via an eye tracking sensor or other user interface). As the user traverses his or her environment, one or the biometric sensors update the biometric data 218, which is then read by the biometric monitoring module 208.

The GPS location module 210 determines the location of the user via one or more GPS sensors selected from the sensors 102. In one embodiment, the one or more GPS sensors provide one or more GPS coordinates representing the user's location, which are stored as GPS coordinate data 222. The GPS coordinate data 222 includes the user's current location, an origin location representing the starting point for a path the user is to traverse through his or her environment, and a destination location representing the end point for the path. Using a user interface, such as the eye tracking sensor or other user input interface, the user can designate his or her current location as the origin location for the path to be traversed. The user can then designate a destination point using the user input interface, such as by selecting a virtual object projected on the transparent acousto-optical display 103 or by identifying a location in his or her environment as seen through the display 103. As discussed below, the pathfinding module 214 uses the GPS coordinates of the origin location and the GPS coordinates of the selected destination location in determining a path for the user to traverse using the AR device 105.

As the user of the AR device 105 is likely to use the AR device 105 in different environments, the AR device 105 is configured with a pathfinding selection module that is configured to select a pathfinding algorithm best suited for a given type of terrain. For example, the terrain may be smooth and relatively flat (e.g., a parking lot, a soccer field, a flat stretch of road, etc.), hilly and uneven, or smooth and flat in some parts and hilly in an even in other parts. In one embodiment, the terrain type is determined by analyzing one or more elevation values associated with corresponding GPS coordinates near or around the user of the AR device 105. In another embodiment, the terrain type is determined by analyzing an elevation value associated with one or more points of a point cloud representing the environment near or around the user of the AR device 105. Should a given percentage of the one or more elevation values exceed a given threshold (e.g., 50%), the terrain type may be determined as “hilly” or “uneven.” Similarly, should a given percentage of the one or more elevation values fall below a given threshold (e.g., 50%), the terrain type may be determined as “smooth” or “flat.”

Accordingly, machine-readable memory 122 includes terrain data 224 that electronically represents the terrain where the user of the AR device 105 is located. The terrain data 224 may include one or more two-dimensional maps, topography maps, point cloud maps, three-dimensional geometric maps, or any other kind of electronic map or combination thereof. To select the terrain data 224 corresponding to the user's location, the pathfinding module 214, in one embodiment, invokes the GPS location module 210 to obtain the user's current GPS coordinates, and then selects the terrain data 224 that corresponds to the obtained GPS coordinates.

In one embodiment, the terrain data 224 includes segments of terrain data 224 that are indicated as safe (e.g., for travel, for movement, etc.) and/or unsafe (e.g., hazardous, not suitable for travel, etc.). The segments may be preconfigured by a human operator or a service that provides the terrain data 224. Further still, and in an alternative embodiment, a portion or segment of the environment may be identified as unsafe when provided with one or more of the user biometric attribute values. For example, and without limitation, the AR device 105 may implement a lookup table that correlates various user biometric attribute values with different types of terrain. In this way, a terrain type of “steep” or “inclined” may be identified as unsafe when a user biometric attribute value is provided that indicates that the user relies on a wheelchair or other assisted-mobility device.

Alternatively, or additionally, the user of the AR device 105, using a user input interface or the like, may indicate portions of his or her environment safe or unsafe as viewed through the transparent acousto-optical display 103. Where a segment or portion of the terrain data 224 is marked or identified as “unsafe,” the pathfinding selection module 212 and/or the pathfinding module 214 are configured to exclude such portions of the terrain data 224 from the virtual path determination. In this manner, the AR device 105 facilitates navigation of an environment (or portions thereof) that may be difficult or hazardous for the user to traverse.

In some instances, terrain data 224 may be unavailable for the user's location. For example, the user may be located inside a museum, a shopping mall, a grocery store, or other interior location where the terrain data 224 is unavailable. In this regard, the augmented reality application 116, via the GPS location module 210, may create a point cloud map of the terrain near and around the user via one or more sensors 102 of the AR device 105 (e.g., via one or more infrared sensors and/or millimeter wave sensors). The point cloud created by the GPS location module 210 may then be stored as terrain data 224 or may be uploaded to a server, via a wireless communication interface integrated into the AR device 105, for additional processing or conversion (e.g., to a format or other three-dimensional coordinate system). Where the point cloud is converted, the AR device 105 may receive the converted point cloud as terrain data 224, which is then used by the pathfinding selection module 212 as discussed below.

The pathfinding selection module 212 is configured to select a pathfinding algorithm suitable for the user's environment and corresponding to the terrain data 224. Accordingly, the AR device 105 is configured with one or more pathfinding algorithms 226. The algorithms included in the pathfinding algorithms 226 include, but are not limited to A*, Theta*, HAA*, Field D*, and other such algorithms or combination of algorithms. Examples of such pathfinding algorithms are discussed in Algfoor, et al., “A Comprehensive Study on Pathfinding Techniques for Robotics and Video Games,” International Journal of Computer Games Technology, Vol. 2015, which is incorporated by reference herein in its entirety. After the pathfinding selection module 212 selects a pathfinding algorithm 226, the pathfinding algorithm module 212 invokes the pathfinding module 214.

The pathfinding module 214 is configured to determine a path from the user's location to a selected destination given a selected pathfinding algorithm and corresponding terrain data 224. Furthermore, one or more of the algorithms 226 is associated with corresponding pathfinding constraints 228. The pathfinding constraints 228 may include the type of terrain, the height of the terrain relative to the user, whether the terrain is safe or hazardous, whether the terrain is compatible with the physical ability of the user (e.g., wheelchair accessible) and other such constraints. Furthermore, the biometric safety thresholds 220, determined from the biometric data 218, may form the basis for one or more of the pathfinding constraints 228. In this regard, the pathfinding constraints 228 may further include a breathing rate threshold, an activity level threshold, a heart rate threshold, and other such constraints. One example of a constraint-based approached to pathfinding is discussed in Leenen et al., “A Constraint-based Solver for the Military Unit Path Finding Problem,” In Proceedings of the 2010 Spring Simulation Multiconference (SpringSim '10), which is incorporated by reference herein in its entirety.

Accordingly, the pathfinding module 214 executes the selected pathfinding algorithm using the user's location (e.g., as provided as a set of coordinates), a selected destination (e.g., a second set of coordinates), terrain data (e.g., as a set of two-dimensional grids, three-dimensional grids, a point cloud, or other set of data), a selected pathfinding algorithm (e.g., A*, Theta*, HAA*, Field D*, etc.), and one or more associated pathfinding constraints 228. The resulting output is one or more coordinates that form a path from the user's location (e.g., an origin location) to the selected destination (e.g., a destination location). The coordinates, and any intermittent points therebetween, are stored as the determined path data 230. The determined path data 230 may then be displayed, via the AR rendering module 204, on the transparent acousto-optical display 103.

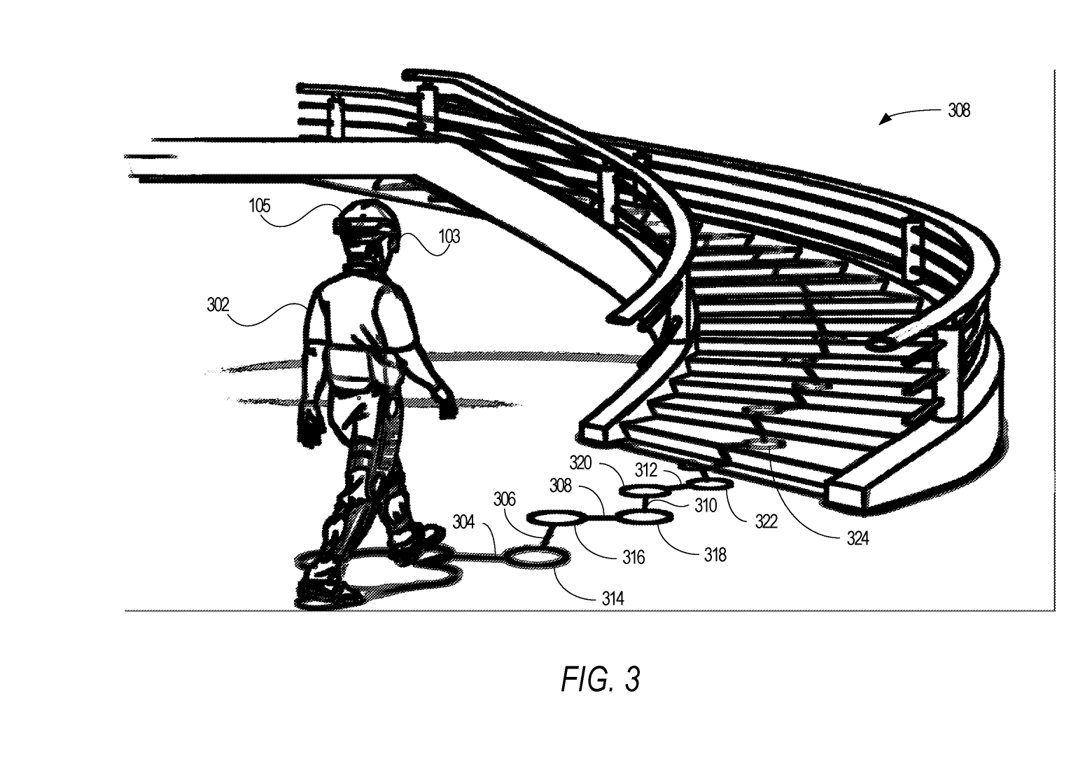

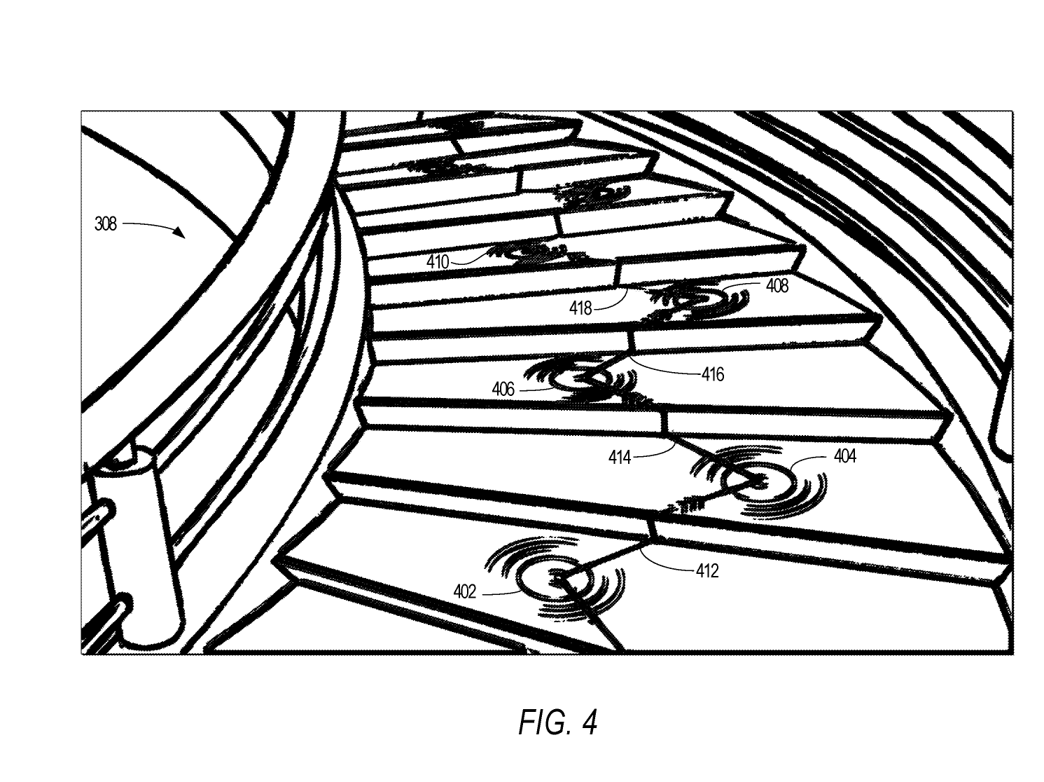

FIG. 3 illustrates an environment 308 where the AR device 105 displays a virtual path for the user 302 to follow, according to an example embodiment. In one embodiment, the virtual path is generated from the determined path data 230.

The determined path data 230 includes a sequential set of coordinates that indicate a path the user should follow to reach the selected destination from the user's location. In addition, one or more of the coordinates are designated as waypoints, where a waypoint indicates where the user 302 should place his or her feet to traverse the virtual path. FIG. 3 illustrates these waypoints as waypoints 314-324. In addition, the waypoints 314-324 are connected by segments 304-312, which are displayed as vectors that indicate the direction and distance from one waypoint to another waypoint. The segments 304-312 and the waypoints 314-324 form a virtual path that is displayed to the user 302 via the acousto-optical display 103. In one embodiment, the waypoints 314-324 correspond to one or more coordinates of the terrain data 224 such that, when the virtual path is displayed, the virtual path appears overlaid on the environment 308.

FIG. 4 illustrates another view of the virtual path displayed by the AR device 105, according to an example embodiment. As shown in FIG. 4, the virtual path includes waypoints 402-410 connected by segments 412-418. In this manner, the segments 412-418 provide guidance to the user 302 for placing his or her feet as the user 302 follows the virtual path. In one embodiment, the user's progress along the virtual path is monitored by the GPS location module 210, which provides the monitored GPS coordinates to the pathfinding module 214. In response, the pathfinding module 214 updates the user's progress along the virtual path.

In addition, the biometric monitoring module 208 is configured to communicate one or more signals to the pathfinding module 214 that indicate whether the pathfinding module 214 should present an option to the user 302 to re-determine the virtual path. In particular, as the user progresses along the virtual path (e.g., through one or more of the coordinates 314-324 or coordinates 402-410), the biometric monitoring module 208 compares the user's monitor biometric data 218 with corresponding one or more biometric safety thresholds 220. In one embodiment, should one or more of these biometric safety thresholds 220 be met or exceeded, the biometric monitoring module 208 communicates a signal to the pathfinding module 214 that the user should be presented with a prompt as to whether the virtual path should be re-determined. In another embodiment, the biometric monitoring module 208 may be configurable such that the user can indicate the type of virtual path he or she would like to follow. For example, the types of virtual path may include an “easy” virtual path, a “medium” virtual path, and a “difficult” virtual path. In this regard, each of the types of virtual paths may be associated with corresponding biometric safety threshold values such that the biometric safety threshold values are representative of the type of path. In one embodiment, the machine-readable memory 122 includes a lookup table where the rows of the lookup table correspond to the types of virtual paths and the columns correspond to the biometric safety threshold attributes (e.g., heart rate, activity level, lung capacity, etc.). In this embodiment, the biometric monitoring module 208 signals the pathfinding module 214 based on the type of virtual path that the user has previously selected. Further still, in this embodiment, the biometric safety threshold values, corresponding to the selected virtual path type, form a set of the pathfinding constraints 228.

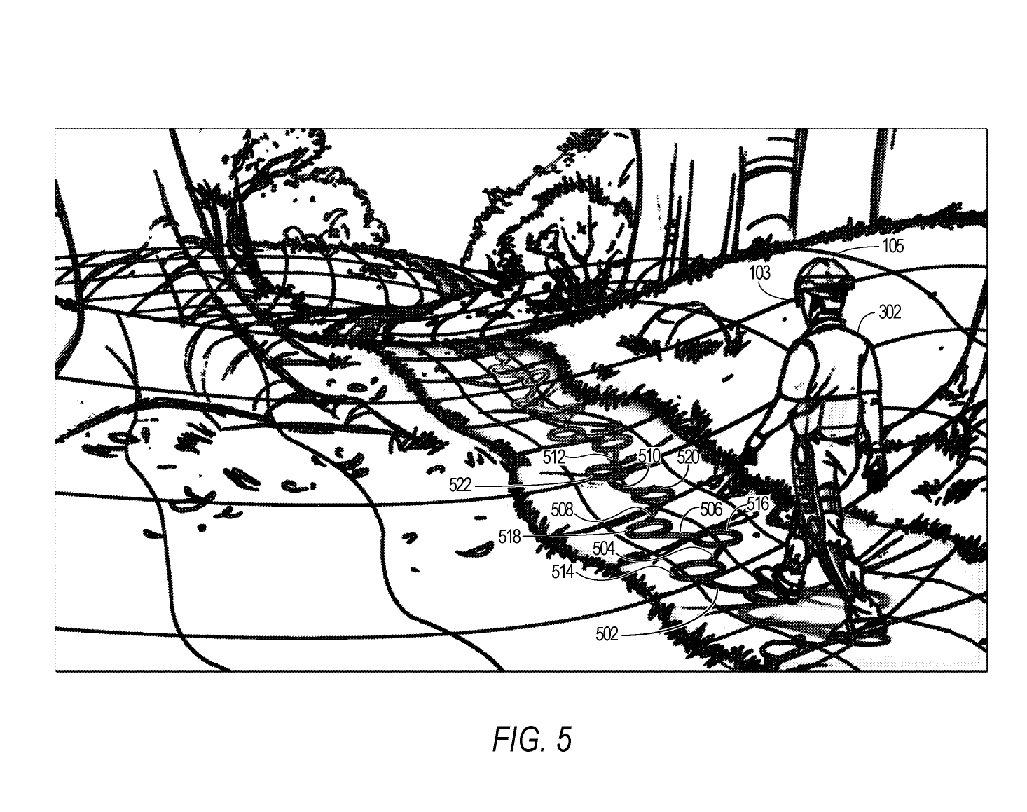

FIG. 5 illustrates another environment where the AR device 105 displays a virtual path for the user 302 to follow, according to an example embodiment. In the example shown in FIG. 5, the user 302 is located in an outdoor environment. Accordingly, the AR device 105 loads terrain data 224 corresponding to the user's GPS coordinates (e.g., GPS coordinate data 222) provided by the GPS location module 210. In addition, the pathfinding module 214 has determined a virtual path, which is displayed as waypoints 514-522 and segments 502-512. As discussed above, should the user 302 encounter difficulties while traversing the virtual path indicated by waypoints 514-522, the pathfinding module 214 may prompt the user 302 whether to re-determine the virtual path.

In addition, the AR device 105 is configured to re-determine the virtual path in the event that an object or other obstacle presents itself while the user 302 is traversing the virtual path. In one embodiment, the AR device 105 performs real-time, or near real-time, scanning of the environment (e.g., the environment 308) via one or more of the sensors 102, such as one or more of the CCD cameras, one or more of the CMOS cameras, one or more of the infrared sensors, and the like. In this embodiment, the AR device 105 continuously constructs a point cloud or other electronic image (e.g., a digital picture) of the environment.

Using one or more path intersection detection algorithms, the AR device 105 determines, via the pathfinding module 214, whether an object or other obstacle intersects with one or more portions of the determined virtual path. If this determination is made in the affirmative, the pathfinding module 214 modifies the terrain data 224 to include one or more of the dimensions of the detected object or obstacle. Thereafter, the pathfinding module 214 then re-determines the virtual path using the modified terrain data 224. The re-determined virtual path is then displayed via the transparent acousto-optical display 103.

In some instances, the detected object or obstacle may be continuously moving through the user's environment. Accordingly, in some embodiments, the path intersection detection algorithm is implemented in a real-time, or near real-time, basis such that the virtual path is re-determined and/or re-displayed so long as the detected object or obstacle intersects (e.g., impedes the user's movement) the displayed virtual path.

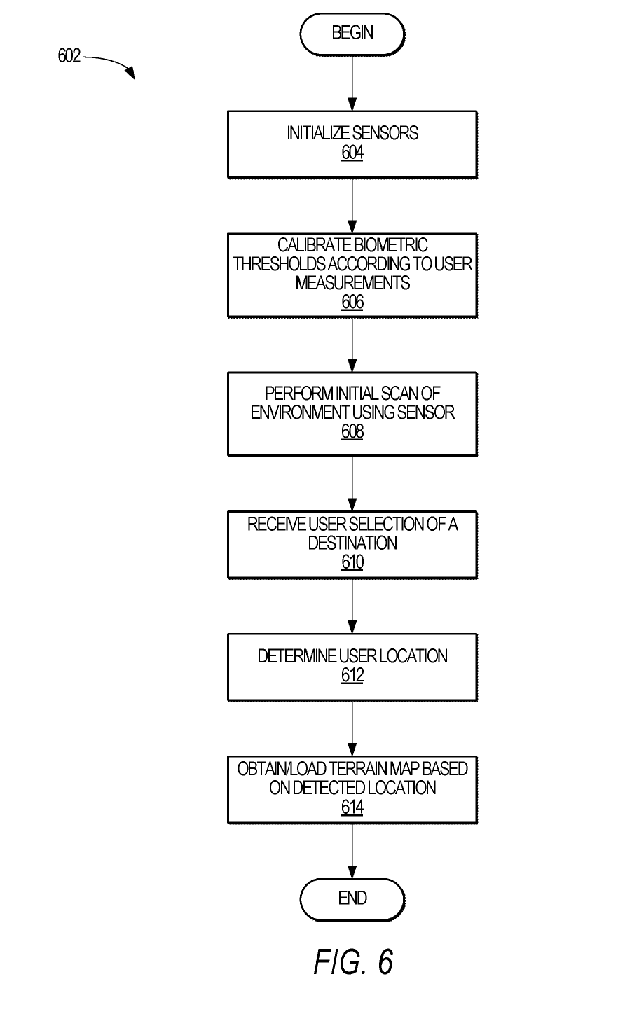

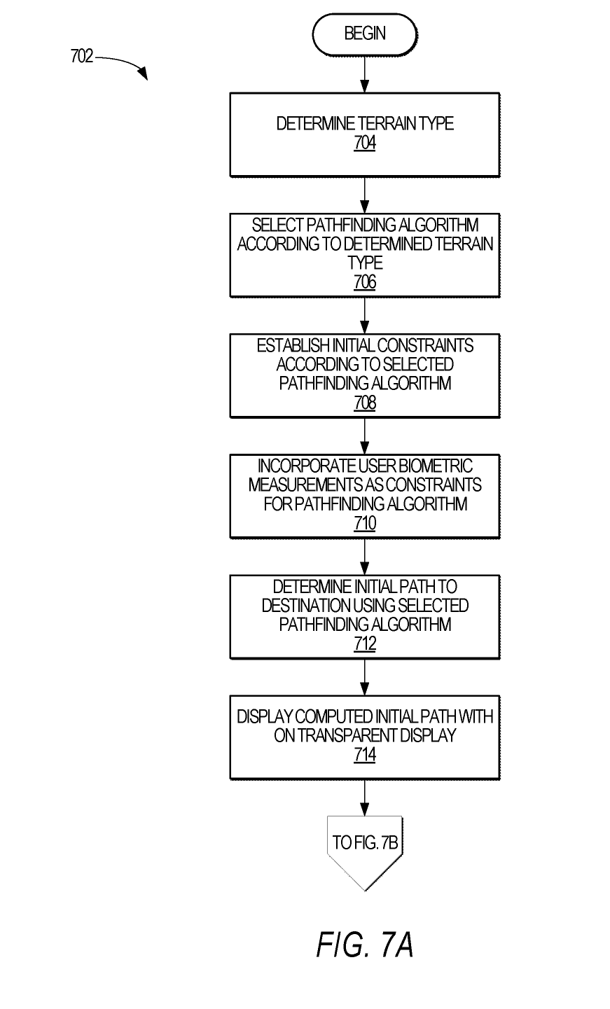

FIG. 6 illustrates a method 602 for initializing the AR device 105, according to an example embodiment. The method 602 may be implemented by one or more components of the AR device 105, and is discussed by way of reference thereto. Initially, one or more of the sensors 102 are initialized (Operation 604). Initializing the sensors 102 may include calibrating the sensors, taking light levels, adjusting colors, brightness, and/or contrast, adjusting a field-of-view, or other such adjustments and/or calibrations.

Next, the AR device 105 calibrates one or more of the biometric safety thresholds 220 (Operation 606). In this regard, calibrating the one or more biometric safety thresholds 220 may include monitoring one or more of the user's biometric attributes via the biometric monitoring module 208, and querying the user to provide information about his or her health. As discussed above, the biometric monitoring module 208 request that the user provide his or her age, his or her height and/or weight, the amount of physical activity that the user engages in on a weekly basis, and other such health-related questions. Alternatively, the AR device 105 may prompt the user to engage in some activity or exercise to establish the biometric safety thresholds 220.

The AR device 105 then conduct the scan of the environments near or around using one or more of the sensors 102 (Operation 608). In one embodiment, the initial scan in the environment includes obtaining one or more GPS coordinates via the GPS location module 210. Should the GPS location module 210 being able to obtain such coordinates (e.g., the user is in an indoor environment), the GPS location module 210 may then conduct the scan of the environment near and/or around the user using one or more infrared sensors and/or one or more depth sensors. The scan then results in a point cloud, where the points of the cloud can be assigned a corresponding three-dimensional coordinate. In this manner, the GPS location module 210 is suited to determine the user's location whether the user is in an outdoor or indoor environment.

The AR device 105 may then prompt the user to identify a destination to which she or she would like to travel (Operation 610). As discussed above, the user may select the destination using an eye tracking sensor other user input interface (e.g., a pointing device, a keyboard, a mouse, or other such input device). The selected destination may then be stored as GPS coordinate data 222. The AR device 105 may then determine the user's location, whether such location is in absolute or relative terms (Operation 612). In one embodiment, the user's location is determined as a set of GPS coordinates, which are stored as GPS coordinate data 222. In another embodiment, the user's location may be established as an origin for a three-dimensional coordinate system where GPS data for the user's location is unavailable.

The AR device 105 then obtains an electronic map corresponding to the user's location, such as by retrieving an electronic map or portion thereof from the terrain data 224 (Operation 614). In some embodiments, the AR device 105 communicates wirelessly with an external system to obtain the terrain data 224. In other embodiments, the point cloud created by the GPS location module 210 is used to create a corresponding electronic map and stored as terrain data 224.

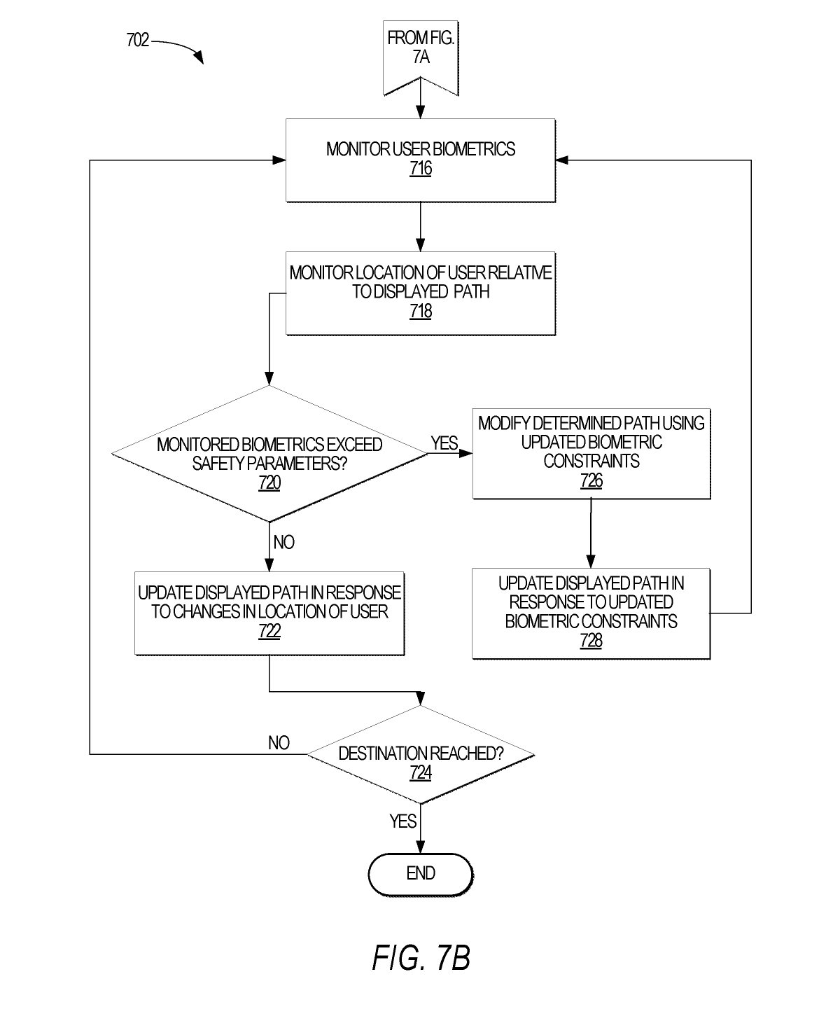

FIGS. 7A-7B illustrate a method 702 for selecting a pathfinding algorithm and determining a virtual path for a user to follow using the AR device 105 of FIG. 1, according to an example embodiment. The method 702 may be implemented by one or more components of the AR device 105 and is discussed by way of reference thereto.

Referring first to FIG. 7A, the AR device 105 initially determines the type of terrain near and/or around the user (Operation 704). As discussed above, the terrain or environment near and/or around the user may flat, smooth, uneven, hilly or combinations thereof. Based on the determined terrain type, the AR device 105 then selects a pathfinding algorithm, via the pathfinding selection module 212, suited for the determined terrain type (Operation 706). In one embodiment, the pathfinding selection module 212 may select a pathfinding algorithm corresponding to the determined terrain type via a lookup table, where rows of the lookup table represent pathfinding algorithms and columns of the lookup table correspond to terrain types.

The pathfinding module 214 then establishes one or more pathfinding constraints 228 according to the selected pathfinding algorithm (Operation 708). In addition to the pathfinding constraints 228 associated with the selected pathfinding algorithm, the pathfinding module 214 incorporates one or more user biometric measurements (e.g., biometric data 218 and/or biometric safety thresholds 220) into the pathfinding constraints 220 (Operation 710).

The pathfinding module 214 then determines a virtual path to the destination selected by the user (e.g., from Operation 610) using the user's current location, the selected destination, the selected pathfinding algorithm, and the one or more pathfinding constraints 220 (Operation 712). The determined virtual path is then displayed on a transparent acousto-optical display 102 community coupled to the AR device 105 (Operation 714). In some embodiments, portions of the virtual path may be depth encoded according to the physical locations to which the portions correspond.

Referring to FIG. 7B, the AR device 105, via the biometric monitoring module 208, the monitors the user's biometrics as he or she follows the virtual path (Operation 716). In addition, the AR device 105, via the GPS location module 210, monitors the user's location relative to the determined virtual path (Operation 718). While monitoring the user, the AR device 1050 determines whether one or more of the monitor biometric measurements has met or exceeded a corresponding biometric safety threshold (Operation 720). This determination may be made by comparing a value of the monitored biometric measurements with a value of the biometric safety threshold.

If this determination is made in the affirmative (e.g., “Yes” branch of Operation 720), the AR device 105 may modify the biometric constraints to a value less than one or more of the biometric safety thresholds. The AR device 105 then modifies the determined virtual path using the updated biometric constraints (Operation 726). The AR device 105 then displays the updated virtual path (Operation 728). In an alternative embodiment, the AR device 105 displays a prompt to the user querying the user as to whether he or she would like to have the virtual path predetermined. In this alternative embodiment, the AR device 105 may not update the biometric constraints and/or the virtual path should the user indicate that he or she does not desire that the virtual path be updated.

Should the AR device 105 determined that the monitored biometrics have not met or exceeded one or the biometric safety thresholds (e.g., “No” branch of Operation 720), the AR device 105 may update the display path in response to changes in the location of the user (Operation 722). For example, the AR device 105 may change one or more features of the displayed virtual path, such as its color, line markings, waypoint shape, or other such feature, in response to the user having reached a given location along the virtual path. The AR device 105 then determines whether the user has reached his or her destination (Operation 724). If so (e.g., “Yes” branch of Operation 724), then the method 702 may terminate and the AR device 105 may display a prompt indicating that the user has reached his or her destination. If not (e.g., “No” branch of Operation 724), then the method 702 returns to Operation 716.

In this manner, this disclosure provides a system and method for assisting the user in navigating a terrain or environment. As the virtual path is displayed to the user using augmented reality, the user can easily see how the virtual path aligns with his or her environment. This makes it much easier for the user to find his or her footing as he or she traverses or moves through the environment. Further still, the systems and methods disclosed herein can assist those who are undergoing physical therapy or those who may worry about over exerting themselves. Thus, this disclosure presents advancements in both the augmented reality and medical device fields.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-7B are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

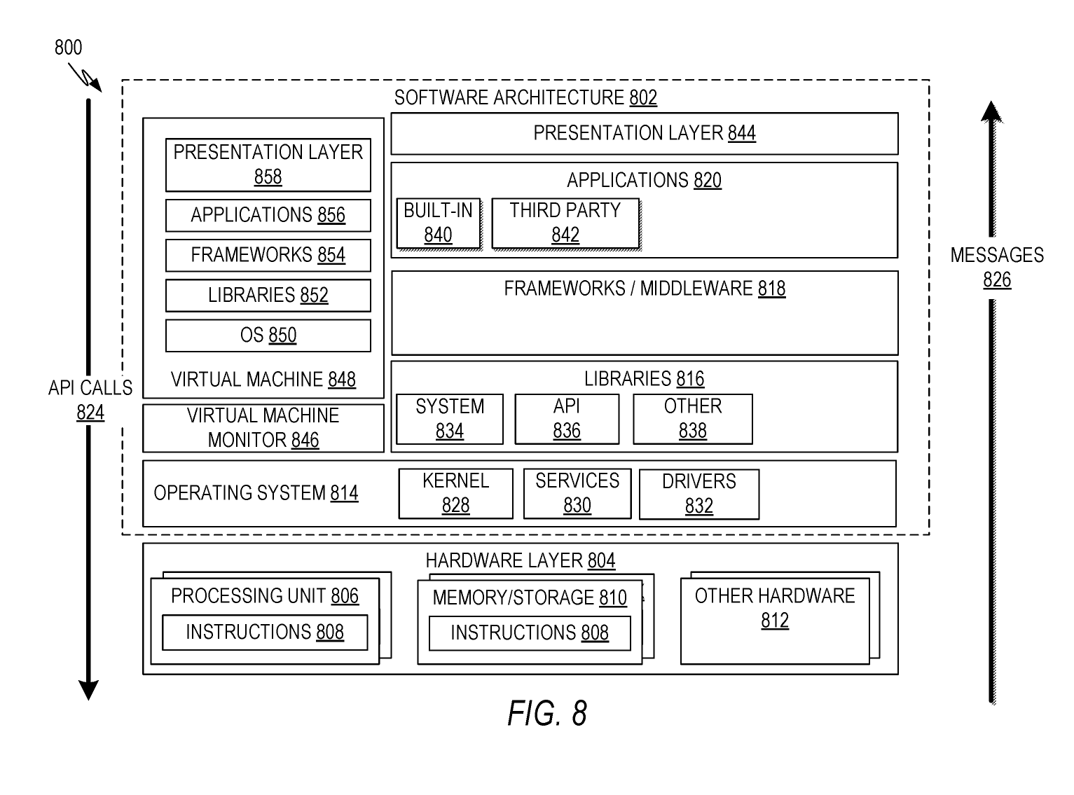

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 800 of FIG. 8 that includes, among other things, processors 810, memory 830, and I/O components 840. A representative hardware layer 804 is illustrated and can represent, for example, the machine 800 of FIG. 8. The representative hardware layer 804 comprises one or more processing units 806 having associated executable instructions 808. Executable instructions 808 represent the executable instructions of the software architecture 802, including implementation of the methods, modules and so forth of FIGS. 1-7B. Hardware layer 804 also includes memory and/or storage modules 810, which also have executable instructions 808. Hardware layer 804 may also comprise other hardware as indicated by 812 which represents any other hardware of the hardware layer 804, such as the other hardware illustrated as part of machine 800.

In the example architecture of FIG. 8, the software 802 may be conceptualized as a stack of layers where each layer provides particular functionality. For example, the software 802 may include layers such as an operating system 814, libraries 816, frameworks/middleware 818, applications 820 and presentation layer 822. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, some mobile or special purpose operating systems may not provide a frameworks / middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 and/or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 includes built-in applications 840 and/or third party applications 842. Examples of representative built-in applications 840 may include, but are not limited to, a contacts application, a browser application, a book reader application, a location application, a media application, a messaging application, and/or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™ Android™, Windows® Phone, or other mobile operating systems. In this example, the third party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system 834, APIs 836, and other libraries 838), frameworks / middleware 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (such as the machine of FIG. 8, for example). A virtual machine is hosted by a host operating system (operating system 814 in FIG. 8) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

### Example Machine Architecture and Machine-Readable Medium

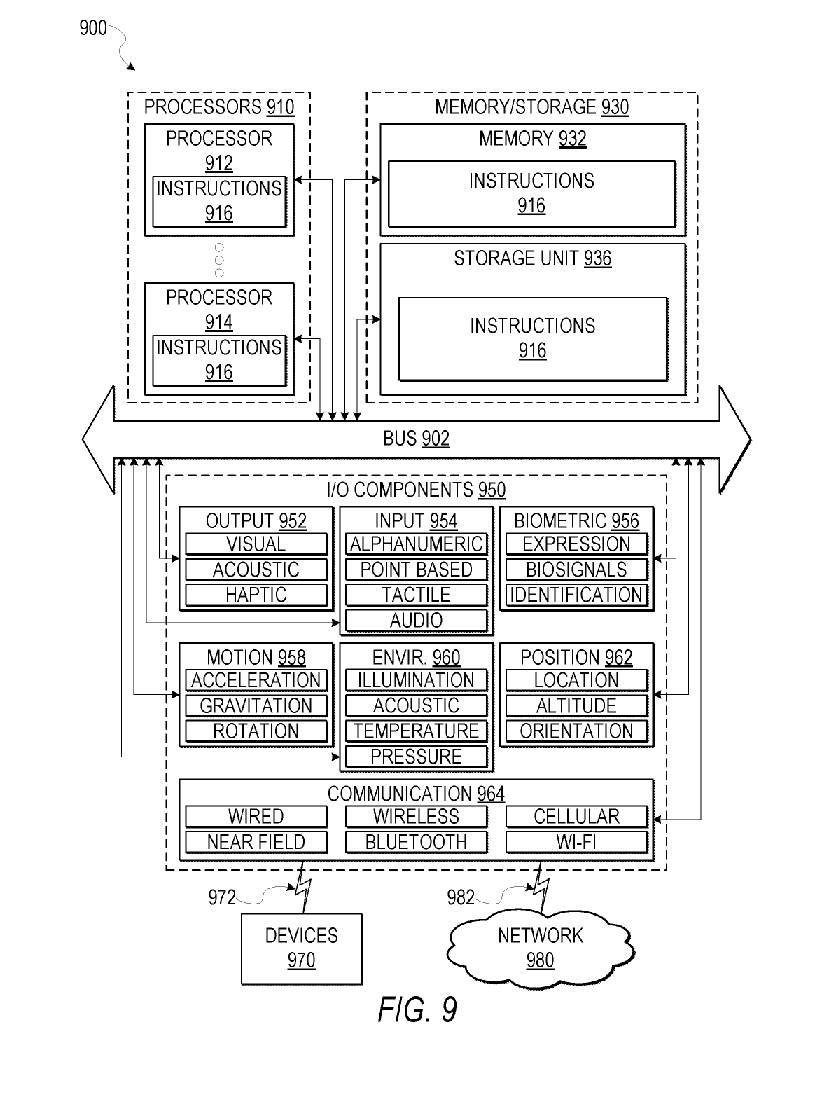

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions may cause the machine to execute the methodologies discussed herein. Additionally, or alternatively, the instructions may implement any modules discussed herein. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A method for determining and displaying a virtual path using augmented reality, the method comprising:
receiving, with at least one hardware processor, sensor data about an environment from at least one sensor communicatively coupled to the at least one hardware processor;
determining, with the at least one hardware processor, a terrain type for the environment based on the sensor data;
determining, with the at least one hardware processor, a virtual path using the sensor data and the determined terrain type; and
displaying, on a display communicatively coupled to the at least one hardware processor, the virtual path, wherein the virtual path appears overlaid on corresponding portions of the environment when viewed through the display.

2. The method of claim 1, further comprising:
monitoring, with the at least one hardware processor, biometric data for a user using at least one biometric sensor communicatively coupled to the at least one hardware processor; and wherein
determining the virtual path comprises determining the virtual path based on the monitored biometric data.

3. The method of claim 2, further comprising:
receiving user-provided health-related information about the user; and wherein determining the virtual path comprises determining the virtual path based on the user-provided health-related information.

4. The method of claim 1, further comprising:
recognizing an object in the environment; and
wherein determining the virtual path further comprises determining the virtual path based on the recognized object.

5. The method of claim 1, further comprising:
identifying a portion of the environment as being unsafe; and
wherein determining the virtual path further comprises determining the virtual path to circumnavigate the identified portion of the unsafe environment.

6. The method of claim 1, further comprising:
detecting an obstacle intersecting the determined virtual path;
modifying terrain data associated with the determined virtual path to account for the detected obstacle;
re-determining the determined virtual path to circumnavigate the detected obstacle based on the modified terrain data; and
displaying the re-determined virtual path.

7. The method of claim 1, further comprising:
monitoring, with the at least one hardware processor, biometric data for a user using at least one biometric sensor communicatively coupled to the at least one hardware processor;
determining that the monitored biometric data meets or exceeds one or more biometric safety threshold values;
in response to the determination that the monitored biometric data meets or exceeds the one or more biometric safety threshold values, determining a plurality of virtual paths, wherein each of the virtual paths selected from the virtual paths are associated with a different set of biometric safety threshold values;
presenting an option to select at least one of the virtual paths of the plurality of virtual paths as the virtual path to use instead of the determined virtual path; and
in response to a selection of the at least one virtual path, displaying the selected at least one virtual path.

8. A system for determining and displaying a virtual path using augmented reality, the system comprising:
a computer-readable memory storing computer-executable instructions thereon; and
at least one hardware processor communicatively coupled to the computer-readable memory that, when the computer-executable instructions are executed, configures the system to:
receive sensor data about an environment from at least one sensor communicatively coupled to the at least one hardware processor;
determine a terrain type for the environment based on the sensor data;
determine a virtual path using the sensor data and the determined terrain type; and
display, on a display communicatively coupled to the at least one hardware processor, the virtual path, wherein the virtual path appears overlaid on corresponding portions of the environment when viewed through the display.

9. The system of claim 8, wherein the system is further configured to:
monitor, with the at least one hardware processor, biometric data for a user using at least one biometric sensor communicatively coupled to the at least one hardware processor; and wherein
the determination of the virtual path comprises determining the virtual path based on the monitored biometric data.

10. The system of claim 9, wherein the system is further configured to:
receive user-provided health-related information about the user; and wherein the determination of the virtual path comprises determining the virtual path based on the user-provided health-related information.

11. The system of claim 8, wherein the system is further configured to:
recognize an object in the environment; and
wherein the determination of the virtual path further comprises determining the virtual path based on the recognized object.

12. The system of claim 8, further wherein the system is further configured to:
identify a portion of the environment as being unsafe; and
wherein the determination of the virtual path further comprises determining the virtual path to circumnavigate the identified portion of the unsafe environment.

13. The system of claim 8, wherein the system is further configured to:
detect an obstacle intersecting the determined virtual path;
modify terrain data associated with the determined virtual path to account for the detected obstacle;
re-determine the determined virtual path to circumnavigate the detected obstacle based on the modified terrain data; and
display the re-determined virtual path.

14. The system of claim 8, wherein the system is further configured to:
monitor, with the at least one hardware processor, biometric data for a user using at least one biometric sensor communicatively coupled to the at least one hardware processor;
determine that the monitored biometric data meets or exceeds one or more biometric safety threshold values;
in response to the determination that the monitored biometric data meets or exceeds the one or more biometric safety threshold values, determine a plurality of virtual paths, wherein each of the virtual paths selected from the virtual paths are associated with a different set of biometric safety threshold values;
present an option to select at least one of the virtual paths of the plurality of virtual paths as the virtual path to use instead of the determined virtual path; and
in response to a selection of the at least one virtual path, display the selected at least one virtual path.

15. A computer-readable medium storing computer-executable instructions thereon that, when executed by at least one hardware processor, causes a system to perform a plurality of operations, the plurality of operations comprising:
receiving sensor data about an environment from at least one sensor communicatively coupled to the at least one hardware processor;
determining, a terrain type for the environment based on the sensor data;
determining a virtual path using the sensor data and the determined terrain type; and
displaying, on the display communicatively coupled to the at least one hardware processor, the virtual path, wherein the virtual path appears overlaid on corresponding portions of the environment when viewed through the display.

16. The computer-readable medium of claim 15, wherein the plurality of operations further comprises:
monitoring, with the at least one hardware processor, biometric data for a user using at least one biometric sensor communicatively coupled to the at least one hardware processor; and wherein
determining the virtual path comprises determining the virtual path based on the monitored biometric data.

17. The computer-readable medium of claim 16, wherein the plurality of operations further comprises:
receiving user-provided health-related information about the user; and wherein determining the virtual path comprises determining the virtual path based on the user-provided health-related information.

18. The computer-readable medium of claim 15, wherein the plurality of operations further comprises:
recognizing an object in the environment; and
wherein determining the virtual path further comprises determining the virtual path based on the recognized object.

19. The computer-readable medium of claim 15, wherein the plurality of operations further comprises:
identifying a portion of the environment as being unsafe; and
wherein determining the virtual path further comprises determining the virtual path to circumnavigate the identified portion of the unsafe environment.

20. The computer-readable medium of claim 15, wherein the plurality of operations further comprises:
detecting an obstacle intersecting the determined virtual path;
modifying terrain data associated with the determined virtual path to account for the detected obstacle;
re-determining the determined virtual path to circumnavigate the detected obstacle based on the modified terrain data; and
displaying the re-determined virtual path.
